(19) United States
(12) Patent Application Publication
(10) Pub. No.: US 2007/0158619 A1
(43) Pub. Date: Jul. 12, 2007

(54) Electroplated composite coating

(76) Inventors: Yucong Wang, West Bloomfield, MI (US); Charles H. Olk, Leonard, MI (US); Wei-Xiang Chen, Hangzhou (CN); Jian-Ping Tu, Hangzhou (CN); Zhu-De Xu, Hangzhou (CN)

Correspondence Address: CHARLES H. ELLERBROCK;General Motors Corporation, Legal Staff, Mail Code 482-C23-B21, P.O. Box 300, Detroit, MI, 48265-3000, US

(21) Appl. No.: 11/330,508

(22) Filed: Jan. 12, 2006

(51) Int. Cl. H01B 1/12

(52) U.S. Cl. 252/500

(57) ABSTRACT

An electroplated composite coating is deposited on a substrate using an electroplating solution that includes metal cations of a metallic matrix to be deposited and carbon nanotubes. The composite coating includes the metallic matrix and carbon nanotubes disposed in the matrix to improve coating mechanical and tribological properties.

### FIELD OF THE INVENTION

The present invention relates to electroplated coatings and, more particularly, to an electroplated composite coating comprising carbon nanotubes in a metallic matrix and an electroplating method to make same.

### BACKGROUND OF THE INVENTION

Nickel composite electroplated coatings are increasingly replacing chrome plating and other plated coatings in service applications. For example, nickel-ceramic composite coatings wherein the ceramic comprises boron nitride particles and aluminum oxide particles have been used to replace iron plating for aluminum cylinder bores of automotive, marine and lawn mower engines. Other applications for such electroplated coatings have included piston skirts for automotive, marine, motorcycle and lawn mower engines, engine cylinder bores, vehicle body parts, and tools.

The discovery and development of bulk synthesis processes to make carbon nanotubes stimulated research into potential applications for carbon nanotubes in nanoscale devices, hydrogen storage materials, energy storage and conversion materials, and high performance composite materials. For example, metal-based composites have been reported by J. P. Tu et al. in “Tribological Properties of Carbon Nanotube Reinforced Copper Composites”, Tribol. Lett. 10, pp. 225-228 (2001) as well as by A. K. Sharma et al. in “Carbon Nanotube Composite Synthesized by Ion-Assisted Pulsed Laser Deposition”, Mater. Sci. Eng. B 79, pp. 123-127 (2001). Such metal-based composites included a metal matrix such as Fe, Al, Ni, Cu or their alloys having carbon nanotubes therein as a reinforcement constituent in the matrix.

### SUMMARY OF THE INVENTION

The invention provides a method of electroplating a composite coating on a substrate, as well as the composite coating, wherein the composite coating includes carbon nanotubes residing in a metallic matrix.

An illustrative method embodiment of the invention involves providing an electroplating solution including metallic cations of the metallic matrix to be deposited and carbon nanotubes, disposing the substrate as a cathode and an anode in the electroplating solution of an electrolytic cell, and operating the electrolytic cell in a manner to electrodeposit the metallic matrix containing carbon nanotubes as a coating on the substrate. The electroplating solution preferably includes a dispersing agent effective to disperse the carbon nanotubes in the electroplating solution such that the carbon nanotubes are dispersed in the metallic matrix of the electroplated composite coating. The length to diameter ratio of the carbon nanotubes included in the electroplating solution preferably is selected to enhance dispersion of the carbon nanotubes in the solution. The carbon nanotubes can be pretreated, such as by ball milling or sonication, prior to introduction into the electroplating solution to provide a desired length to diameter ratio to this end.

The invention can be practiced to produce composite coatings wherein the amount of carbon nanotubes in the metallic matrix can be controlled to provided desired mechanical and/or tribological properties.

Other advantages and features of the present invention will become apparent from the following description.

### DESCRIPTION OF THE DRAWINGS

FIG. 1 is a graph of wear rate versus the volume fraction of carbon nanotubes (CNT) in a composite coating pursuant to an illustrative embodiment of the invention at three different loads of 12N, 16N, and 20N.

FIG. 2 is a graph of friction coefficient versus the volume fraction of carbon nanotubes (CNT) in a composite coating pursuant to an illustrative embodiment of the invention at three different loads of 12N, 16N, and 20N.

FIG. 3 is a photomicrograph of a cross-section of an illustrative composite coating and Zn—Ni bond-coat on an Al—Si alloy substrate. The composite coating comprises carbon nanotubes dispersed in a Ni—P matrix, although the carbon nanotubes cannot be seen in FIG. 3 as a result of their size.

### DESCRIPTION OF THE INVENTION

The invention involves the electroplating of a composite coating on a substrate wherein the composite coating includes a metallic matrix having carbon nanotubes disposed in the matrix. The invention can be practiced to electroplate the composite coating on any substrate, which can be a metallic material (metal or alloy), or a non-metallic material such as a plastic, ceramic, composite, or other material. The non-metallic material can be provided with an electrically conductive coating thereon to enable electroplating of the composite coating thereon. Regardless of whether a metallic or non-metallic substrate is used, the substrate preferably is provided with a metallic bond-coat thereon prior to electroplating of the composite coating such that the bond-coat resides as a metallic interlayer between the substrate and the composite coating to improve adherence of the composite coating. Although certain embodiments of the invention are described below in connection with electroplating the composite coating on an aluminum alloy substrate having a Zn—Ni bond-coat thereon, these embodiments are offered merely for purposes of illustration and not limitation of the invention since the invention is not limited to these materials.

Moreover, the invention is not limited to any particular metallic matrix. For example, the metallic matrix can include any suitable metal or alloy matrix for capturing the carbon nanotubes and selected in dependence on the particular service application for the composite coated substrate. Although certain embodiments of the invention are described below in connection with electroplating a composite coating having a Ni based matrix, such as a Ni—P alloy matrix, these embodiments are offered merely for purposes of illustration and not limitation of the invention since the invention is not limited to any particular matrix material.

The electroplated composite coating contains a suitable amount of carbon nanotubes in the metallic matrix for a particular service application of the coated substrate. For purposes of illustration and not limitation, the carbon nanotubes can be present in amounts ranging from about 5 volume % to about 16 volume % of the coating. In the electroplated composite coating, the carbon nanotubes are captured in the metallic matrix with the carbon nanotubes typically being in random orientation in the matrix.

The carbon nanotubes can have any suitable length to outer diameter ratio for a particular service application, although the carbon nanotubes disposed in the metallic matrix preferably have a length to outer diameter ratio in the range of about 5 to about 100 for purposes of illustration and not limitation. The outer diameter of most of the carbon nanotubes ranges from about 20 to about 50 nanometers. As a result of their nano-diameter, the interior of the hollow carbon nanotubes captured in the metallic matrix typically is not filled with the metallic matrix, although the invention envisions that the nanotubes can be filled with the metallic matrix in some instances.

Various conventional synthesis processes can be employed to make the carbon nanotubes. For example, carbon nanotubes for use in the metallic matrix can be made by chemical catalytic pyrolysis of a carbon-bearing gas, arc discharge, laser ablation, and template-based synthesis techniques. Alternately, appropriate carbon nanotubes can be purchased from various commercial manufacturers, such as Carbolex, Inc. 234 McCarty Court, Lexington, Ky., 40508 USA. Although certain illustrative embodiments of the invention are described below in the examples for making carbon nanotubes, these embodiments are offered merely for purposes of illustration and not limitation of the invention since the invention is not limited to any particular synthesis process for making carbon nanotubes.

The length to diameter ratio of the carbon nanotubes included in the electroplating solution preferably is selected to enhance dispersion of the carbon nanotubes in the solution. To this end, the carbon nanotubes may be synthesized to have an appropriate average length to diameter ratio for dispersion in the electroplating solution and thus the metallic matrix, or the as-synthesized carbon nanotubes may be subjected to a post-synthesis treatment to reduce their lengths in order to provide an appropriate average length to diameter ratio. For example, the synthesized carbon nanotubes can be sonicated, ball milled or otherwise treated to reduce their as-synthesized lengths to provide the appropriate length to diameter ratio for dispersion in the electroplating solution and thus the metallic matrix. Although certain embodiments of the invention are described below in connection carbon nanotubes which have been treated by sonication or ball milling, these embodiments are offered merely for purposes of illustration and not limitation of the invention since the invention is not limited to such illustrative embodiments.

The invention is practiced by preparing an electroplating bath or solution that has dissolved therein metallic cations of the metallic matrix to be deposited and that contains carbon nanotubes to be included in the metallic matrix. In the examples set forth below, the metallic cations comprise Ni⁺² to deposit a Ni matrix for purposes of illustration and not limitation. As mentioned, the carbon nanotubes can be as-synthesized, or post-synthesis treated to provide an appropriate length to diameter ratio that enhances their dispersion in the bath or solution. The electroplating bath or solution can be suitable aqueous based or other solution having appropriate constituents, temperature and pH for depositing the composite coating on the substrate. The electroplating solution includes a dispersing agent, such as a surfactant, effective to disperse the carbon nanotubes in the electroplating solution such that the carbon nanotubes will be dispersed in the metallic matrix of the electroplated composite coating. The parameters employed for operation of the electrolytic cell in which the substrate is the cathode are empirically selected in dependence on the nature of electroplating bath or solution used as well as the type and thickness of composite coating to be deposited on the substrate. For purposes of illustration and not limitation, a composite coating pursuant to the invention typically may have a thickness of less than about 30 micrometers. Although certain embodiments of the invention are described below in connection with a particular aqueous based electroplating bath composition, temperature and pH and particular electrolytic cell operational parameters, these embodiments are offered merely for purposes of illustration and not limitation of the invention since the invention is not limited to such illustrative embodiments.

The following examples are offered to further illustrate certain embodiments of the invention without limiting the scope of the invention. In these embodiments, carbon nanotubes were synthesized by chemical catalytic pyrolysis of acetylene using a Co—Mg complex oxide as the catalyst, the Co—Mg complex oxide being prepared from Co(No₃)₂) and Mg(NO₃)₂ by a sol-gel method. For example, an acetylene-nitrogen mixture (C₂H₂:N₂=1:5) was introduced into a quartz tubular chamber at a flow rate of 600 ml/min at 923 K for 30 minutes to produce carbon nanotubes. The as-prepared carbon nanotubes were purified by immersion in concentrated nitric acid for 48 hours and then washing with de-ionized water. The purified carbon nanotubes were then treated to reduce their lengths. For example, the carbon nanotubes were suspended in a mixture of concentrated sulfuric acid and nitric acid (volume ratio of 1:3) and then sonicated at room temperature for 48 hours to reduce their lengths so that the average length to diameter ratio was about 20:1, which enhances or facilitates their dispersion in the above electroplating solution. Alternately, the purified carbon nanotubes can be mechanically ball milled for 8 hours with a planetary ball mill using steel balls in an ether liquid at a rotating speed of 430 revolutions/min. The weight ratio of steel balls to purified carbon nanotubes can be 50:1.

Aluminum alloy substrates (such as A356, A380, A390, or A319 alloy) in the form of a plate or a part such as aluminum pistons were pre-treated and then provided with a metallic bond-coat comprising a Zn—Ni alloy (94-95 weight % Zn and 5-6 weight % Ni) to improve adhesion between the substrate and the electroplated composite coating. For example, the substrates were pretreated by being immersed in 0.1 M NaOH aqueous solution for about 30 seconds, rinsed with de-ionized water at 60 degrees C., then dipped in a mixture of concentrated nitric acid and hydrofluoric acid (volume ratio of 2:1) for one minute, and finally rinsed in de-ionized water.

The Zn—Ni bond-coat was applied to the treated substrate by electroless plating using an aqueous bath composition comprised of 5-8 g/L of ZnO, 10-15 g/L of NiCl₂.6H₂O, 100-120 g/L of NaOH, 5-10 g/L of KNaC₄H₄O₈.4H₂O, and 1-2 g/L of FeCl₃.6H₂O per liter of the electroless plating bath. The bath was at a temperature of 20-25 degrees C. The substrate was immersed in the bath typically for about 20 seconds, although immersion times of 10 to 40 seconds can also be used. The thickness of the Zn—Ni bondcoat typically was in the range of about 2.5 to 3 micrometers.

Following deposition of the Zn—Ni bond-coat on the aluminum alloy substrates, a composite coating was electroplated on the bond-coated substrates. The composite coating comprised a Ni—P alloy matrix (10-13 weight % P and balance Ni) and carbon nanotubes of average length to diameter of 20:1 disposed in the matrix. Different composite coatings were electroplated on the bond-coated substrates to evaluate the effects of different amounts of carbon nanotubes in the Ni—P matrix. For example, respective aqueous electroplating solutions were prepared to have 0, 1.0, 2.0, 3.0, 4.0, 5.0 and 6.0 g/L of carbon nanotubes therein.

The aqueous electroplating solution comprised 200-250 g/L of NiSO₄.7H₂O, 35-40 g/L of NiCl₂.6H₂O, 40-50 g/L of H₃PO₄, 4-8 g/L of H₃PO₃, 0-6 g/L of carbon nanotubes as specified in the previous paragraph, and 100-200 mg/L of surfactant ((cetyltrimethyl ammonium bromide (CTAB)). Bath temperature was 70-75 degrees C. Bath pH was 2.5 to 3.0. The bath constituents were dissolved in water such that the NiSO₄.7H₂O and NiCl₂.6H₂O provide Ni⁺² cations in the solution for reduction at the cathode (substrate) to deposit a Ni matrix.

The bond-coated substrates were immersed in the respective electroplating baths as the cathode, together with a Ni plate as an anode and connected to a conventional source of electrical voltage or current, such as a stabilized voltage and current source, to complete an electrolytic cell. An electrical current was passed between the cathode and the anode of the cell. A cathodic current density of 3 A/dm² was determined empirically to produce a relative smooth and bright coating surface, although a range of current densities of 1 to 6 A/dm² was evaluated. A deposition rate of about 0.30 to 0.35 micrometers/min was obtained with the plating solutions having 1 to 6 g/L of carbon nanotubes. The electroplated composite coating can be provided with a thickness of about 15 to about 20 micrometers for purposes of illustration and not limitation, since any suitable coating thickness can be provided for a particular service application.

In order to improve the dispersion of the carbon nanotubes in the electroplating solution, the carbon nanotubes were first dispensed into a small amount of the solution and stirred for 30 minutes. Then, the stirred solution was mixed with the remaining solution. The surfactant (CTAB) was added to the electroplating solution for absorption on the carbon nanotubes to improve their dispersion.

Following electroplating, the electroplated substrates were heat treated at 673 K for one hour in vacuum to form hardening Ni₃P phase precipitates in a substantially Ni matrix, increasing its hardness. Before heat treatment, the crystal structure of the coating was amorphous. After heat treatment, the crystal structure of the coating was crystalline.

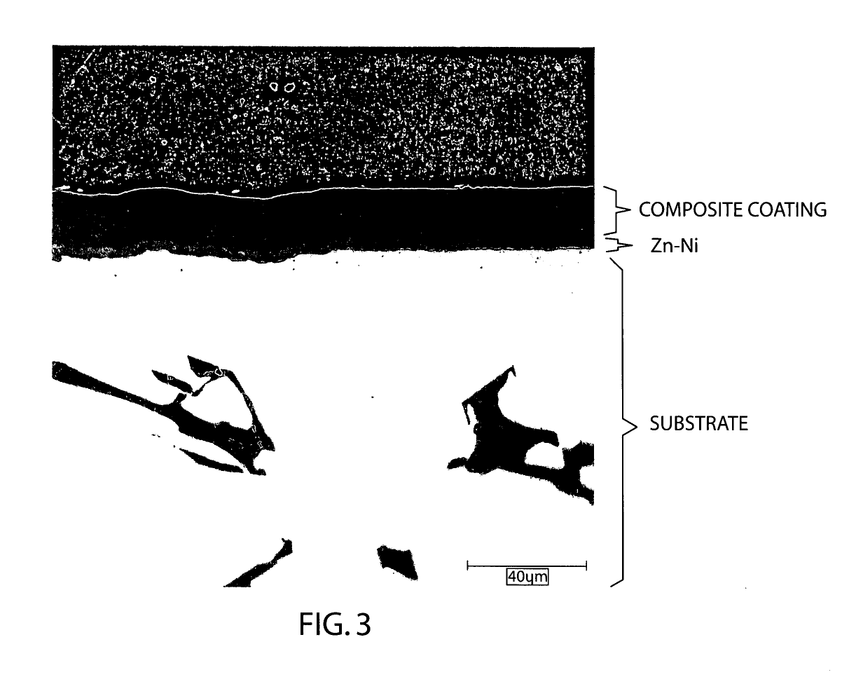

The electroplated and heat treated composite coated substrates were tested to determine the content of carbon nanotubes captured in the Ni—P matrix and the resulting microhardness. The microhardness was measured by a Vickers hardness indenter under a load of 50 g. FIG. 3 shows a photomicrograph of a cross-section of a typical composite coating and Zn—Ni bond-coat together having an aggregate coating thickness of about 20 micrometers on an Al—Si alloy substrate sample tested herein. The carbon nanotubes cannot be seen as a result of their small size.

When no carbon nanotubes were included in the electroplating solution, the coating comprised the Ni matrix layer devoid of carbon nanotubes and having a coating microhardness of 603 Hv. However, when the electroplating solution included 1.0 g/L of carbon nanotubes, the composite coating included 5.6 volume % of carbon nanotubes in the Ni matrix and a microhardness of 661 Hv. When the electroplating solution included 2.0 g/L of carbon nanotubes, the composite coating included 8.9 volume % of carbon nanotubes in the Ni matrix and a microhardness of 705 Hv. When the electroplating solution included 3.0 g/L of carbon nanotubes, the composite coating included 10.8 volume % of carbon nanotubes in the Ni matrix and a microhardness of 745 Hv. When the electroplating solution included 4.0 g/L of carbon nanotubes, the composite coating included 14.2 volume % of carbon nanotubes in the Ni matrix and a microhardness of 780 Hv. When the electroplating solution included 5.0 g/L of carbon nanotubes, the composite coating included 14.7 volume % of carbon nanotubes in the Ni matrix and a microhardness of 807 Hv. When the electroplating solution included 6.0 g/L of carbon nanotubes, the composite coating included 15.3 volume % of carbon nanotubes in the Ni matrix and a microhardness of 893 Hv.

These results demonstrate that the volume fraction of carbon nanotubes in the metallic matrix increases with the increasing content of carbon nanotubes in the electroplating solution. Moreover, when the content of carbon nanotubes in the electroplating solution was equal to or more than 4.0 g/L, the volume fraction of carbon nanotubes in the coating increased at a lower rate. Importantly, the microhardness of the composite coatings increased with the increased volume fraction of carbon nanotubes in the coating.

Wear and friction properties of the composite coated substrates of the above examples having the measured contents of carbon nanotubes (i.e. 0, 5.6, 8.9, 10.8, 14.2, 14.7, and 15.3 volume %) in the composite coating were investigated using a pin-on-disk wear tester with the composite coated substrate serving as the disk under unlubricated conditions. The pin specimen was fabricated from GCr15 steel with a diameter of 5 mm and with a hardness of HRC 56. The average surface roughness of the pin specimen was 0.5 micrometers. Wear tests were conducted in air at a sliding speed of 0.0623 m/s and at loads of 12 N, 16 N, and 20 N. Mass losses of the composite coated substrates were measured with an analytical balance at intervals of 15 minutes throughout the tests. The coefficients of friction were calculated by dividing the measured friction by the normal force, providing unit-less coefficient of friction values.

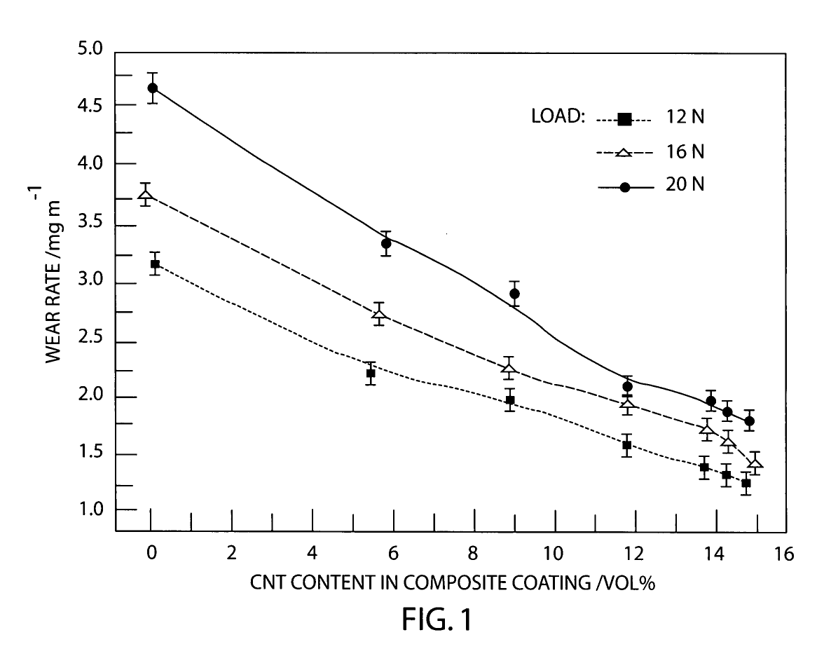

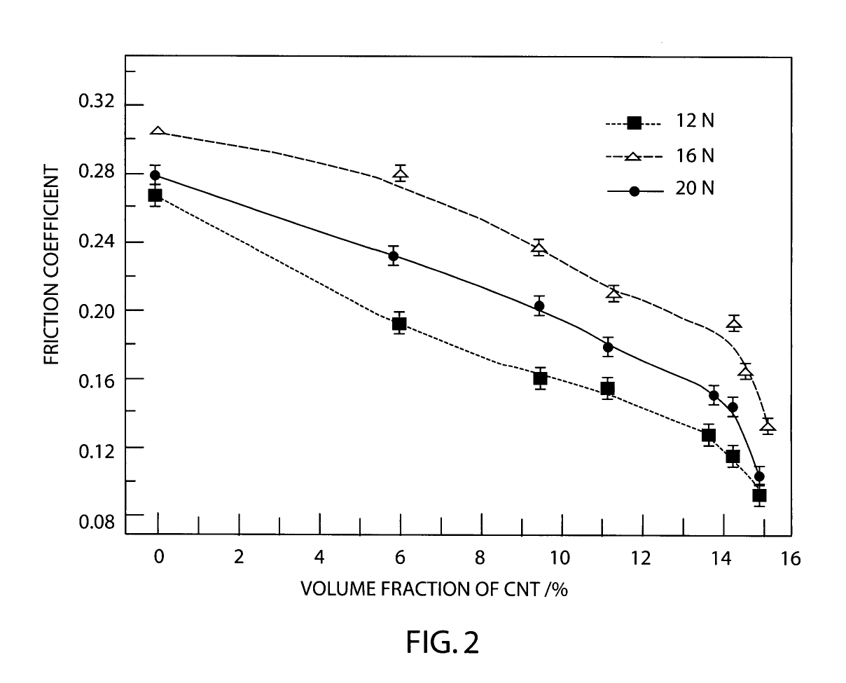

FIGS. 1 and 2 show the wear rate and coefficients of friction of the composite coated substrates under different loads. The wear rate and coefficient of friction of the composite coated substrates decreased with the increasing content of carbon nanotubes (CNT) in the coating. The carbon nanotubes reinforce the composite coating and improve wear resistance and also exhibit a self-lubrication property that results in the observed decrease in the coefficient of friction of the coatings. The favorable effects of the carbon nanotubes on the tribological properties of the composite coatings are evident in FIGS. 1 and 2.

It should be understood that the invention is not limited to the specific embodiments or constructions described above but that various changes may be made therein without departing from the spirit and scope of the invention as set forth in the appended claims.

1. Method of forming a composite coating on a substrate, comprising providing an electroplating solution that includes metal cations of a metallic matrix to be deposited and carbon nanotubes, disposing the substrate as a cathode in the electroplating solution of an electrolytic cell, and operating the electrolytic cell in a manner to electrodeposit a coating comprising the metallic matrix having the carbon nanotubes disposed therein on the substrate.

2. The method of claim 1 wherein a dispersing agent is provided in the electroplating solution effective to disperse the carbon nanotubes in the electroplating solution such that the carbon nanotubes are dispersed in the metallic matrix.

3. The method of claim 1 wherein a length to diameter ratio of the carbon nanotubes is provided to enhance dispersion of the carbon nanotubes in the solution.

4. The method of claim 3 wherein the carbon nanotubes are pretreated prior to introduction into the electroplating solution to provide said length to diameter ratio.

5. The method of claim 1 including the additional step of depositing a metallic bond-coat on the substrate before the composite coating is electrodeposited such that the bond-coat comprises an interlayer between the substrate and the composite coating.

6. The method of claim 1 wherein the electroplating solution includes carbon nanotubes in an amount from 1 to 6 g/L of solution.

7. The method of claim 1 wherein cathodic current density is in the range of about 1 to about 6 A/dm².

8. The method of claim 1 further including heat treating the composite coating to form hardening precipitates in the matrix.

9. Electroplated composite coating, comprising a metallic matrix and carbon nanotubes disposed in the matrix.

10. The coating of claim 9 wherein the carbon nanotubes are present in an amount from about 5 to about 16 volume % of the coating.

11. The coating of claim 9 wherein the carbon nanotubes have an outer diameter from about 20 to about 50 nanometers.

12. The coating of claim 9 having a thickness of less than about 30 micrometers.

13. The coating of claim 9 wherein the carbon nanotubes include a length to diameter ratio of about 5 to about 100.

13. The coating of claim 9 which is heat treated to provide hardening precipitates in the matrix.

14. A coated article, comprising a substrate and an electroplated composite coating on the substrate, said composite coating comprising a metallic matrix and carbon nanotubes disposed in the matrix.

15. The article of claim 14 wherein the carbon nanotubes are present in an amount from about 5 to about 16 volume % of the coating.

16. The article of claim 14 wherein the carbon nanotubes have an outer diameter from 20 to 50 nanometers.

17. The article of claim 16 wherein the coating has a thickness of less than about 30 micrometers.

18. The article of claim 14 wherein the carbon nanotubes include a length to diameter ratio of about 5 to about 100.

19. The article of claim 14 wherein the matrix includes a hardening precipitates.

20. The article of claim 14 including a metallic inlayer between the substrate and the composite coating.
